(19) United States
(12) Patent Application Publication
(10) Pub. No.: US 2015/0106006 A1
(43) Pub. Date: Apr. 16, 2015

(54) METHOD OF ROUTE SCHEDULING AND DEVICES THEREOF

(71) Applicant: Kevin NAJAFI, Richmond Hill (CA)

(72) Inventor: Kevin NAJAFI, Richmond Hill (CA)

(21) Appl. No.: 14/513,470

(22) Filed: Oct. 14, 2014

Related U.S. Application Data
(60) Provisional application No. 61/889,811, filed on Oct. 11, 2013.

(51) Int. Cl. G01C 21/34; G01C 21/36

(52) U.S. Cl. CPC G01C 21/343; G01C 21/36
USPC 701/400

(57) ABSTRACT

A method of planning a route for a plurality of destinations, including: a mobile device receiving information about a plurality of destinations for a day, the information including an address, a time and a duration; the mobile device calculating a start time and a stop time for each of the destinations based on the time received and the duration; the mobile device ordering the destinations in sequence based on the time associated with the destination and displaying a route to said destination in the order to the user; and the mobile device determining a time necessary to travel from each of the destinations to the following destination in the sequence, and if the start time for the following destination exceeds the travel time added to the departure time of the destination, then alerting the user.

### RELATED APPLICATIONS

This application claims the benefit of U.S. Provisional Patent Application No. 61/889,811 filed Oct. 11, 2013, which is hereby incorporated by reference in its entirety.

### FIELD

The invention relates to systems of determining schedules including routes for users, and more particularly to routes with frequent and variable destinations.

### BACKGROUND

Professionals travel frequently to meet with clients for various purposes, for example real estate professionals typically have to travel frequently through a day to meet with sellers and buyers of real estate at different destinations. Each stop at a different location will also take a certain amount of time, as the professional must spent time with the buyer or seller, and perhaps show them the property at the destination.

Solutions in the art do not meet the needs of such a professional. A number of routing applications exist, but most do not provide for multiple destinations; instead they provide directions from a starting location to a destination. Those that do provide for multiple stops, such as those available for delivery services, do not include a variable time component to factor in the amount of time the real estate professional must take at each stop (as a delivery service makes the delivery and then immediately moves on to the next stop).

Related art includes the route planner known as Route4Me available at https://play.google.com/store/apps/details?id=com.route4me.routeoptimizer&hl=en; MyRouteOnline, available at http://www.myrouteonline.com/; U.S. Pat. No. 8,442,550; US 20040030631; U.S. Pat. No. 7,673,248; U.S. Pat. No. 6,385,541 and U.S. Pat. No. 7,640,204.

### SUMMARY

The system and method according to the invention assists users, such as real estate professionals, in planning a route and schedule including leaving from a specific starting location (such as the user's office or home) to multiple destinations (for example to show properties). The system helps the professional be organized as it provides a departure time as well as a duration for each destination; which may be input by the user, or determined by the system, and is adjustable by the user. This allows the user to stay on schedule, for example by providing prompts, such as alarms when the professional should leave a location to arrive at the next destination timely. A map displayable on a mobile computing device shows the recommended departure time for the present location, and estimated arrival time and distance to the next location. The map can display the preferable route for the user to take from the starting location to each of the multiple destinations.

A method of planning a route for a plurality of destinations is provided, including: a mobile device receiving information about a plurality of destinations for a day, the information including an address, a time and a duration for each destination; the mobile device calculating an arrival time and a departure time for each of the destinations based on the time and the duration associated with the destinations; the mobile device ordering the destinations in sequence based on the time associated with the destinations and displaying a route to said destinations in the sequence to the user; and the mobile device determining a time necessary to travel from each of the destinations to the following destination in the sequence, and if the arrival time for the following destination exceeds the travel time added to the departure time of the destination, then alerting the user.

The information about the plurality of destinations may be selected from a database of historical routes and the historical route selected may be amended. The duration for at least one of the plurality of destinations may be predetermined prior to the mobile device receiving the information. The information about the plurality of destinations may be received from a calendar program.

A system for determining a route for a plurality of destinations is provided, including: an application operative on a mobile device, the application configured to receive information about a plurality of destinations for a day, the information including a location and a time for each destination; the application on the mobile device configured to calculate an arrival time and a departure time for each of the destinations based on the time and the duration associated with the destination; the application configured to determine a sequence of the destinations based on the time associated with the destination and determining and displaying a route of the destinations in sequence on a mobile device; and the mobile device configured to determine a time to travel from each of the destinations to the following destination in the sequence, and if the arrival time for the following destination exceeds the travel time added to the departure time of the destination, then alerting the user.

A method of planning a route for a plurality of destinations is provided, including: a mobile device receiving information about a plurality of destinations for a day, the information including a location for each destination and a time for at least one of the destinations, wherein at least another one of the destinations is not associated with an arrival time or a departure time; calculating an arrival time and a departure time for each of the destinations for which a time was received; ordering the destinations for which a time was received in sequence based on the time associated with the destinations; calculating a spare time period between the departure time of the destinations in the sequence and the arrival time of the following destination, including a travel time associated with traveling from the destination to the following destination; and determining if the destination not associated with a time fits within the spare period, including the travel time from the destination to the destination not associated with a time and the destination not associated with a time to the following destination; and if the destination not associated with a time fits within the spare period, adding the destination to the sequence of destinations within the spare period, generating a route from each destination to the following destination and displaying the route on a mobile device.

### DESCRIPTION OF THE FIGURES

FIG. 1 is an embodiment of a destination input selection screen according to the invention.

FIG. 2 is an embodiment of a destination entry screen according to the invention.

FIG. 3 is an embodiment of a destination display screen according to the invention.

FIG. 4 is an embodiment of a map screen showing a route and destinations according to the invention.

FIG. 5 is a flow chart showing an embodiment of a method of providing the route according to the invention.

FIG. 6 is a flow chart showing an embodiment of a destination order determination method according to the invention.

FIG. 7 is a block diagram showing an embodiment of a system according to the invention.

### DETAILED DESCRIPTION

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The methods and displays with the applications described herein are not inherently related to any particular mobile computing device or other apparatus. Various general-purpose systems may be used with programs in accordance with the teachings herein, or it may prove convenient to construct more specialized apparatus to perform the required machine-implemented method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

An embodiment of the invention may be implemented as a method or as a machine readable non-transitory storage medium that stores executable instructions that, when executed by a data processing system, causes the system to perform a method. An apparatus, such as a data processing system, can also be an embodiment of the invention. Other features of the present invention will be apparent from the accompanying drawings and from the detailed description which follows.

### Terms:

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “alternate embodiment”, “another embodiment” and the like mean “one or more (but not all) embodiments of the disclosed invention(s)”, unless expressly specified otherwise.

A reference to “another embodiment”, “alternative” embodiment”, “alternate embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise. The term “plurality” means “two or more”, unless expressly specified otherwise. The term “herein” means “in the present application, including anything which may be incorporated by reference”, unless expressly specified otherwise.

The term “e.g.” and like terms mean “for example”, and thus does not limit the term or phrase it explains. For example, in a sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract of not more than 150 words is required under 37 C.F.R. section 1.72(b). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

The invention can be implemented in numerous ways, including as a process, an apparatus, a system, a computer readable medium such as a computer readable storage medium or a computer network wherein program instructions are sent over optical or communication links. In this specification, these implementations, or any other form that the invention may take, may be referred to as systems or techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

The following discussion provides a brief and general description of a suitable computing environment in which various embodiments of the system may be implemented. Although not required, embodiments will be described in the general context of computer-executable instructions, such as program applications, modules, objects or macros being executed by a computer. Those skilled in the relevant art will appreciate that the invention can be practiced with other computer configurations, including mobile computing devices, such as smart phones, tablets and phablets, multiprocessor systems, microprocessor-based or programmable consumer electronics, personal computers (“PCs”), network PCs, mini-computers, mainframe computers, and the like. The embodiments can be practiced in distributed computing environments where tasks or modules are performed by remote processing devices, which are linked through a communications network. In a distributed computing environment, program modules may be located in both local and remote memory storage devices.

A computer system may be used as a server including one or more processing units, system memories, and system buses that couple various system components including system memory to a processing unit. Computers, such as mobile computing devices, will at times be referred to in the singular herein, but this is not intended to limit the application to a single computing system since in typical embodiments, there will be more than one computing system or other device involved. Other computer systems may be employed, such as conventional and personal computers, where the size or scale of the system allows. The processing unit may be any logic processing unit, such as one or more central processing units (“CPUs”), digital signal processors (“DSPs”), application-specific integrated circuits (“ASICs”), etc. Unless described otherwise, the construction and operation of the various components are of conventional design. As a result, such components need not be described in further detail herein, as they will be understood by those skilled in the relevant art.

A computer system includes a bus, and can employ any known bus structures or architectures, including a memory bus with memory controller, a peripheral bus, and a local bus. The computer system memory may include read-only memory (“ROM”) and random access memory (“RAM”). A basic input/output system (“BIOS”), which can form part of the ROM, contains basic routines that help transfer information between elements within the computing system, such as during startup.

A computer system also includes non-volatile memory. The non-volatile memory may take a variety of forms, for example a hard disk drive for reading from and writing to a hard disk, and an optical disk drive and a magnetic disk drive for reading from and writing to removable optical disks and magnetic disks, respectively. The optical disk can be a CD-ROM, while the magnetic disk can be a magnetic floppy disk or diskette. The hard disk drive, optical disk drive and magnetic disk drive communicate with the processing unit via the system bus. The hard disk drive, optical disk drive and magnetic disk drive may include appropriate interfaces or controllers coupled between such drives and the system bus, as is known by those skilled in the relevant art. The drives, and their associated computer-readable media, provide non-volatile storage of computer readable instructions, data structures, program modules and other data for the computing system. Although a computing system may employ hard disks, optical disks and/or magnetic disks, those skilled in the relevant art will appreciate that other types of non-volatile computer-readable media that can store data accessible by a computer system may be employed, such a magnetic cassettes, flash memory cards, digital video disks (“DVD”), Bernoulli cartridges, RAMs, ROMs, smart cards, etc.

Various program modules or application programs and/or data can be stored in the computer memory. For example, the system memory may store an operating system, end user application interfaces, server applications, and one or more application program interfaces (“APIs”).

The computer system memory also includes one or more networking applications, for example a Web server application and/or Web client or browser application for permitting the computer to exchange data with sources via the Internet, corporate Intranets, or other networks as described below, as well as with other server applications on server computers such as those further discussed below. The networking application in the preferred embodiment is markup language based, such as hypertext markup language (“HTML”), extensible markup language (“XML”) or wireless markup language (“WML”), and operates with markup languages that use syntactically delimited characters added to the data of a document to represent the structure of the document. A number of Web server applications and Web client or browser applications are commercially available, such those available from Mozilla and Microsoft. The operating system and various applications/modules and/or data can be stored on the hard disk of the hard disk drive, the optical disk of the optical disk drive and/or the magnetic disk of the magnetic disk drive.

A computer system can operate in a networked environment using logical connections to one or more client computers and/or one or more database systems, such as one or more remote computers or networks. A computer may be logically connected to one or more client computers and/or database systems under any known method of permitting computers to communicate, for example through a network such as a local area network (“LAN”) and/or a wide area network (“WAN”) including, for example, the Internet. Such networking environments are well known including wired and wireless enterprise-wide computer networks, intranets, extranets, and the Internet. Other embodiments include other types of communication networks such as telecommunications networks, cellular networks, paging networks, and other mobile networks. The information sent or received via the communications channel may, or may not be encrypted. When used in a LAN networking environment, a computer is connected to the LAN through an adapter or network interface card (communicatively linked to the system bus). When used in a WAN networking environment, a computer may include an interface and modem or other device, such as a network interface card, for establishing communications over the WAN/Internet.

In a networked environment, program modules, application programs, or data, or portions thereof, can be stored in a computer for provision to the networked computers. In one embodiment, the computer is communicatively linked through a network with TCP/IP middle layer network protocols; however, other similar network protocol layers are used in other embodiments, such as user datagram protocol (“UDP”). Those skilled in the relevant art will readily recognize that these network connections are only some examples of establishing communications links between computers, and other links may be used, including wireless links. While in most instances a computer will operate automatically, where an end user application interface is provided, a user can enter commands and information into the computer through a user application interface including input devices, such as a keyboard, and a pointing device, such as a mouse. Other input devices can include a microphone, joystick, scanner, etc. These and other input devices are connected to the processing unit through the user application interface, such as a serial port interface that couples to the system bus, although other interfaces, such as a parallel port, a game port, or a wireless interface, or a universal serial bus (“USB”) can be used. A monitor or other display device is coupled to the bus via a video interface, such as a video adapter (not shown). The computer can include other output devices, such as speakers, printers, etc.

The system and method according to the invention allow for a user to schedule a number of meetings or appointments in a day at different locations or destinations. There are several variables involved in each appointment, including a destination (usually a fixed location and provided by the user, particularly for a real estate professional), an arrival time, at which the meeting or appointment begins and a departure time by which the user must leave the location to be able to timely attend the next meeting or appointment at the next destination.

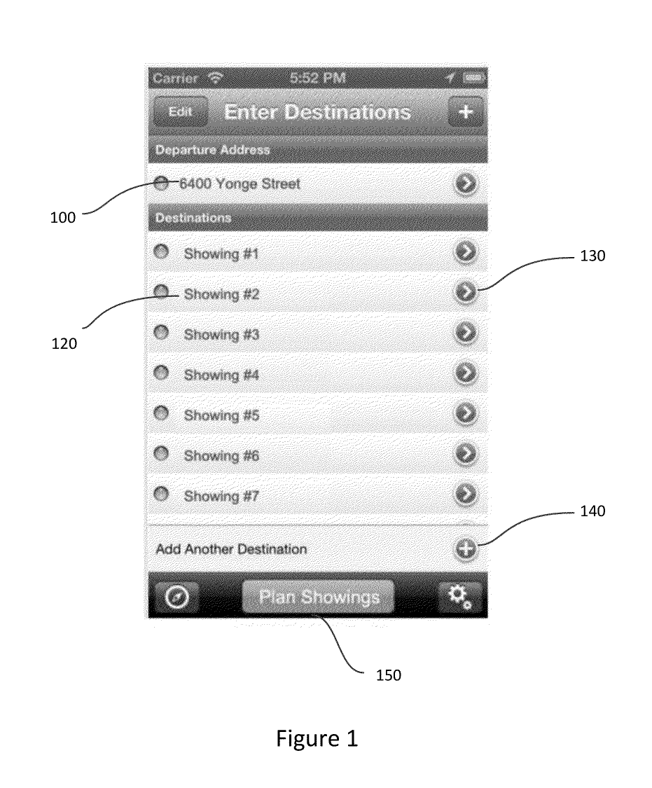

As shown in FIG. 1, a user, for example, a real estate professional, such as a realtor or real estate agent (although the user may be anyone who needs to attend to a number of destinations and spend a certain amount of time at each location), begins by providing a departure address 100 and a number of destinations 120 to the system, typically via a mobile computing device, such as a smart phone or tablet. Departure address 100 will normally be the location the user is starting his or her professional day, and may be the user's home address, office address, or other location. Departure address 100 is typically stored by the system in a database as a default address, so the user is not required to re-enter it into the system each day, although the user may override by providing a different departure address. A user can interact with detail symbol 130 adjacent each destination 120 to enter information about the destination and can interact with addition symbol 140 to add another destination. When the information has been provided, the user can interact with the Plan Showings space or button 150 to move to a destination entry screen or the trip planning stage, if the user has completed the destination entry screen for each destination.

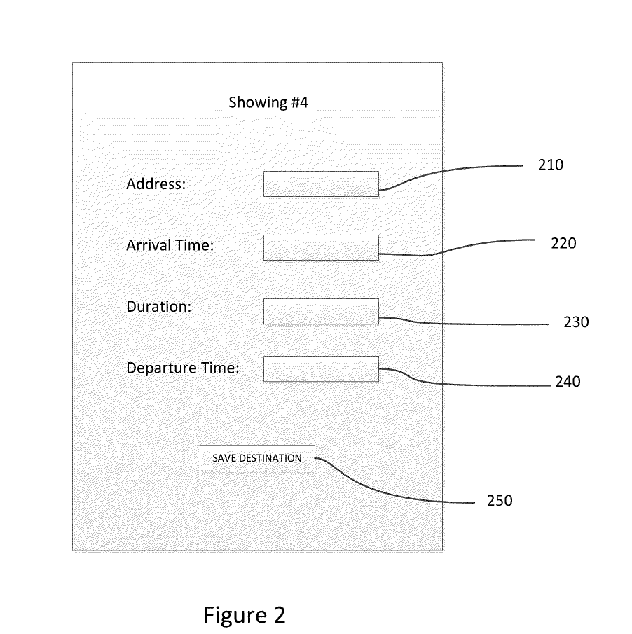

The user completes a screen displayed for each destination, an embodiment of which is shown in FIG. 2. The address of the destination (or name of the destination if the name is already associated with the address in an accessible database) is included in the address space 210. Other information that may be provided includes: the start time, i.e. the time to arrive at that destination, in arrival time space 220; the duration of the meeting in duration space 230; and an end time in end time space 240. At least one of the arrival time, departure time and length of the meeting may be provided for each destination, although alternatively, the system can manufacture a route and schedule if the times are not provided using the addresses of the destinations only and a preferred distance or time calculation. Once the information has been entered the destination can be saved by interaction with the Save Destination button 250.

In one embodiment of the invention the information about meetings, such as name of persons being met, location and arrival and end times, for the day may be extracted from software calendar program, such as Microsoft Outlook, and any of the address space 210, start time space 220, duration space 230 and end time space 240 can be automatically filled, although the user can override.

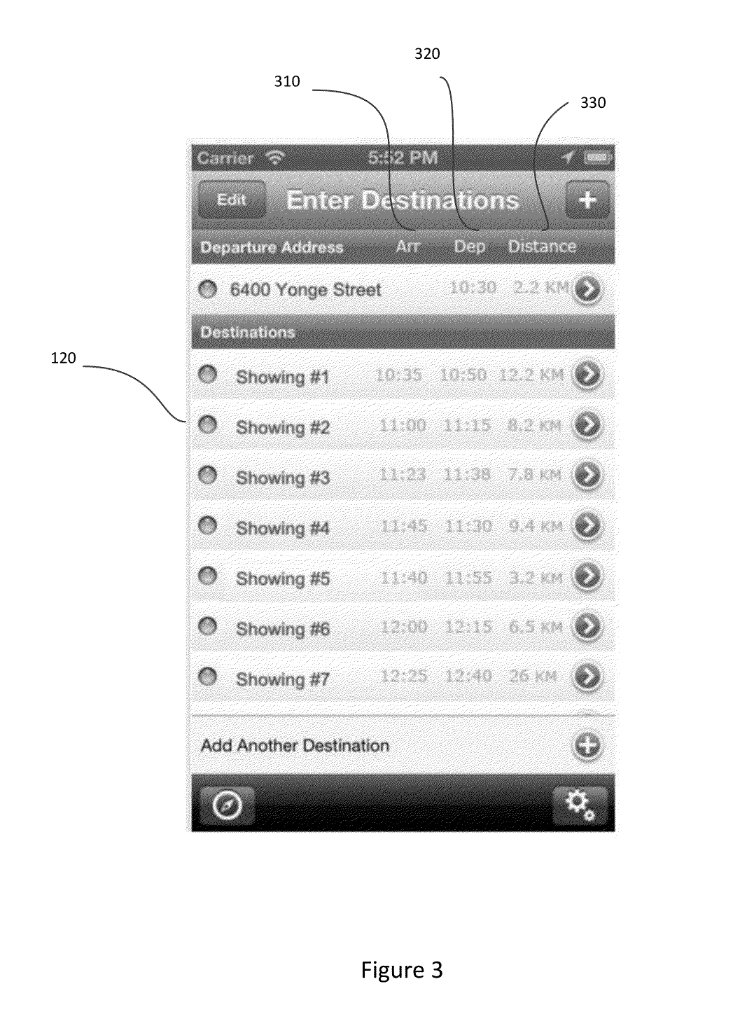

FIG. 3 displays an example of a table of the destinations and a sequence in which to attend them. The rows in the table 300 are the destinations 120, and the columns represent an arrival time 310, departure time 320 and distance 330 to the next destination in the column Each destination 120 (in the embodiment shown, a “showing”), therefore includes an arrival time, a departure time, and a distance to the next destination. To complete this table, several calculations are performed by the system, as discussed below.

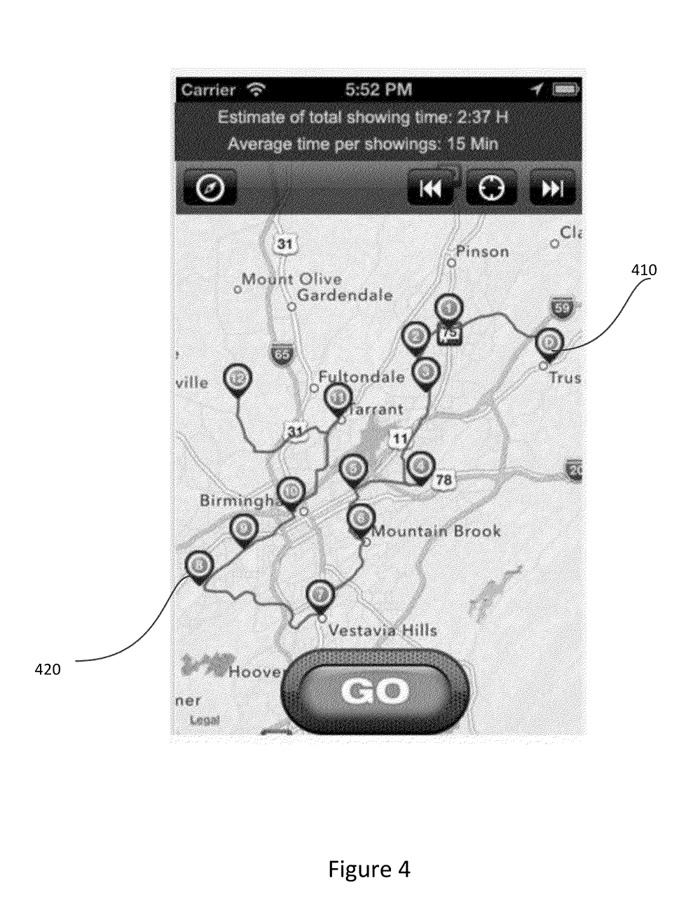

Once the table is completed, the system then generates a route map based on the destinations provided, for example, as shown in FIG. 4 which displays a route map according to an embodiment of the invention based on twelve destinations entered into the system. The departure address 100 is marked with “D” 410, and then displays how the user can proceed throughout the day to each of the destinations indicated by a number 420 in sequence. By interacting with, such as tapping on a number 420, information about that destination, such as who is being met, the address, and the time of arrival and departure may be shown. Statistics about the route may also be presented, for example as shown in FIG. 4, the estimated total showing time (i.e. the total duration value of each destination) and the average time per showing (i.e. the total duration value divided by the number of destinations) is displayed.

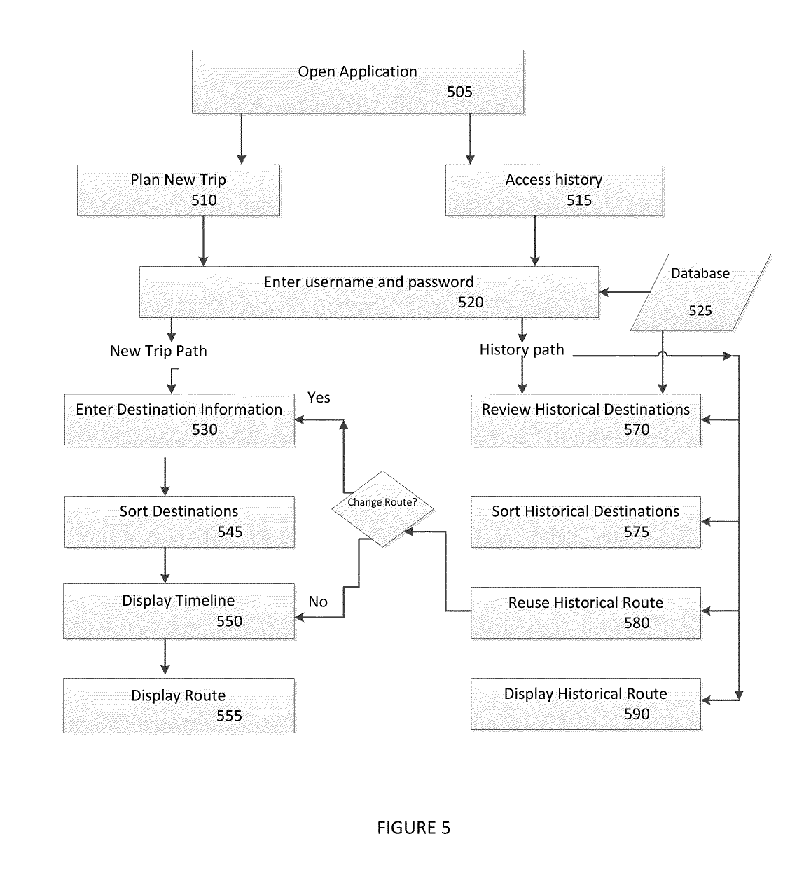

FIG. 5 shows the process by which the route map is generated. The application is first opened and begins to run (step 505). The user then is presented with two options: (1) to plan a new trip (step 510); or (2) to review a previous trip (i.e. a historical record) (step 515). The user then enters their username, password and position (or role) (step 520), or alternatively this could be stored in database 525 and automatically entered.

The next step is the entry of destinations. For each destination an address is provided, and typically, at least two of departure time, arrival time, and duration (step 530); but given two of these entries, the third can be calculated using the formula: arrival time+duration=departure time. The system then sorts the destinations by time of arrival (step 545) and displays a timeline as shown in FIG. 4 (step 550 and route map (step 555). In one embodiment if only a departure time or arrival time is provided, the system will assume a duration time of 15 minutes (or another predetermined duration), which may be revised by the user. The user can change or edit the information entered at any time.

The system allows a user to enter notes, for example after each meeting at a destination, which can be reviewed later via the history. If the user is reviewing his or her history the user can review previous stops at a destination (step 570), and sort them by date (step 575). The user can also reapply a historical route to become the next route (step 580), and simply use the route (step 595) or make any modifications needed. The historical record allows for ease of tracking information such as distances travelled over a day, which may be useful for expense tracking. The historical route can also be shown on the display (step 590).

If the destinations entered are not compatible, for example given the travel time, it is not possible to arrive at a destination by the arrival time given the departure time at a previous destination, the system will prompt the user and ask if the destination information should be changed.

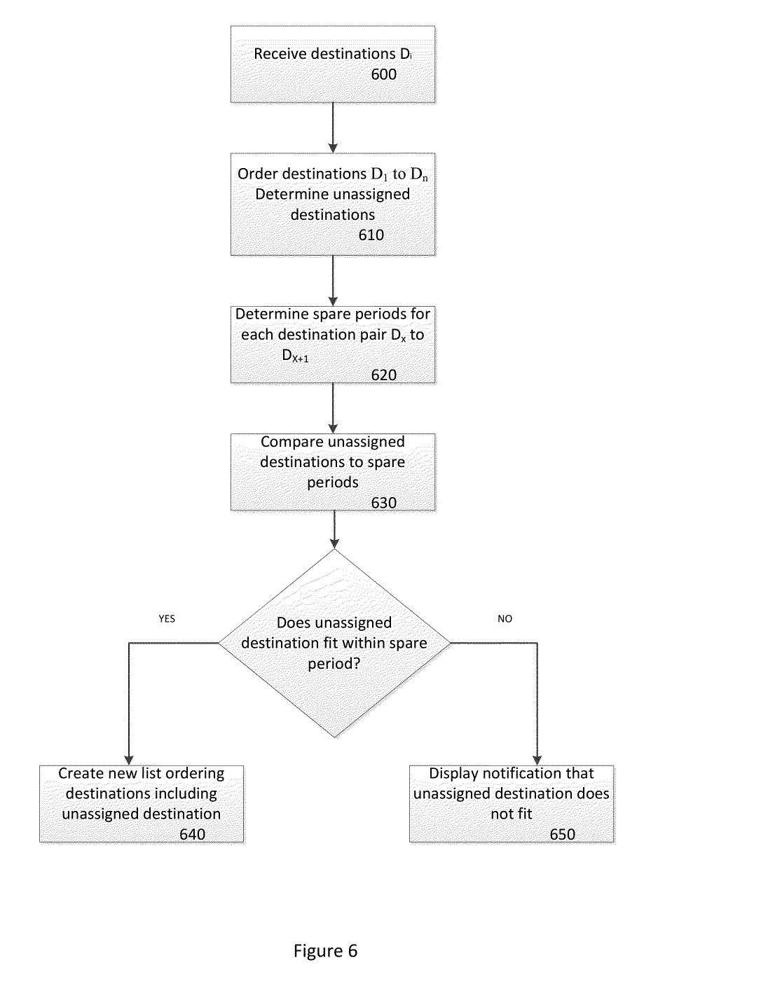

In an alternative embodiment of the invention, the system can perform a best routes analysis based on incomplete information. For example the system may receive a destination with no time constraints at all, or only a duration. This might be useful in a case where the user needs to perform an errand at some time during the day at a particular destination, but the actual time of day at which it occurs does not matter. Alternatively, only a departure time or start time may be entered indicating that the destination must be reached no later than, or any time after, the specified time. A typical embodiment of the method is shown in FIG. 6.

As shown in FIG. 6, the system begins by receiving the destinations (step 600) and ordering the destinations for which a start time is provided, or both a departure time and duration are provided (step 610). This provides a listed order of destinations, D₁ to Dₙ. A number of destinations, referred to as unassigned destinations, may not be included in this initial list as lacking the necessary information, for example Dₐ, which has only a start time, D_{b}, which has only an departure time, and D_{c}, which has no information at all (note in a given process there may be more than one or none of the preceding cases).

The system then calculates the travel time needed to travel from Dₓ to Dₓ₊₁ for each destination on the initial list. If there is more time than needed for a destination Dₓ to reach the following destination Dₓ₊₁, then a spare time period, including a start time, end time and the two locations, Dₓ and Dₓ₊₁ are calculated (step 620). Each spare time period is then compared to the unassigned destinations (step 630), to determine if there it there is sufficient time in the spare time period to allow for the user to travel to the unassigned destination from Dₓ, spend the needed duration there, and travel to Dₓ₊₁ to arrive before the start time of Dₓ₊₁. If the unassigned destination has a start time or departure time, these also must be satisfied by the start time and end time of the spare time period. If there is sufficient time, the unassigned destination can be placed between destination Dₓ and Dₓ₊₁, and a new list created (step 640), with the unassigned destination becoming Dₓ₊₁. If no duration is assigned to a destination it is provided an assumed predefined duration, such as fifteen minutes.

If after insertion of unassigned destinations, one or more unassigned destinations are not yet on the list, the system can restart the process, having removed the unassigned destinations, and attempt to place them in a different order, until finding a solution in which all unassigned destinations are placed in the list (or determining that one or more cannot be inserted given the constraints). If one or more unassigned destinations cannot be placed in the list, then the list presented has the fewest number of unassigned destinations in the iterations performed by the system.

Once the unassigned destinations have been inserted (or it is determined they cannot be inserted within the time constraints), the new list is presented to the user and the user is prompted to revise any remaining unassigned destinations (step 650).

Alternatively, the system can simply assign a predetermined duration, for example of fifteen minutes to each destination for which only a start time or departure time are provided, thereby removing any uncertainty as to when the times related to the destination occur.

When the system determines a best path from each destination to the next destination ordered by time, the path, or route can be displayed on a map such as those provided by Google Maps or Apple. The user's location is marked on the map using GPS or other location systems. The system may warn the user by indicating when there is insufficient time to make it to a destination from the previous destination given the estimated travel time necessary, for example if the user is late departing a particular destination.

The system allows notes to be added for each destination so that the user can record the results of showings or meetings for later review.

Once the destinations have been entered, the user can begin by proceeding to the first destination. When the time to depart from that destination to the next is about to occur, the system can use the mobile computing device to send a reminder to the user that they should departing, or soon should depart. The system may indicate the reminder to the user via an alarm, email or text message.

The user can modify destinations at any time, for example in response to a cancellation or new appointment, in which case the system will reorder the destinations incorporating the new information and update the list and route accordingly A “Take me back to start” selectable option allows the user to change the map to remove destinations not yet reached and alter the only destination to match the original starting location.

If the user elects to view a history they can select by choosing from a calendar or by entering a date or address, or route of interest. Once the route is displayed to the user, the user can select a destination and review their notes relating to the destination or edit and update the notes.

The user can also select a particular destination and receive a list of all the days in which that destination appeared on routes for that user. The user can also select a previous route (“apply again”) and make amendments to that route rather than entering each destination.

In an alternative embodiment of the invention, the system can provide a preferred route based only on the destination, and an assumed duration. For example, if the user is a real estate professional, the user may input the addresses of the properties they want to show to clients as destinations and optionally, an approximate time or sequence associated with each property. The system can then sort the addresses based on their location to minimize either the time spent travelling or the distance traveled, and inform the real estate professional which destination they should arrive at first, second, etc. while providing the travel distance, route, and timing associated with each destination. This assists the real estate professional in booking appointments based on the order and suggested times generated by the system.

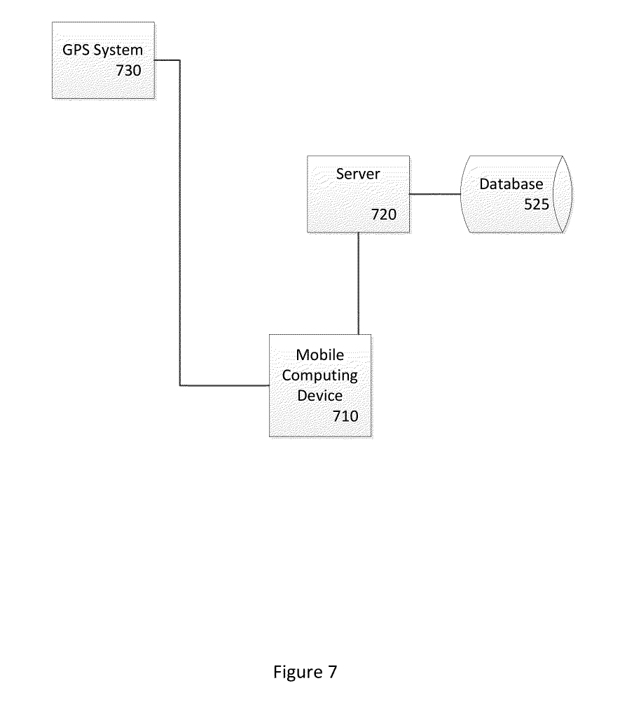

FIG. 7 displays an embodiment of a system according to the invention. User operates mobile computing device 710. Mobile computing device 710 is in communication, typically wireless communication with server 720 which has access to database 525 containing the history of the user and the user's username and password. Server 720 typically provides or has access to, the software creating the routes for the user. Mobile computing device 710 is also in communication with GPS system 730 to allow for rapid determination of the location of the mobile computing device. Alternatively, server 720 could be absent, and mobile computing device may have all the information needed, including database 525.

In the methods taught herein, the various acts may be performed in a different order than that illustrated and described. Additionally, the methods can omit some acts, and/or employ additional acts.

Changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

Further and in addition to the disclosure provided above, it will be readily apparent to one of ordinary skill in the art that the various processes and methods described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., a computer program.

A “processor” means one or more microprocessors, central processing units (CPUs), computing devices, microcontrollers, digital signal processors, or like devices or any combination thereof.

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth M., and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of a system include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various methods described above may omit some acts, include other acts, and/or execute acts in a different order than set out in the illustrated embodiments.

The present methods, systems and articles also may be implemented as a computer program product that comprises a computer program mechanism embedded in a computer readable storage medium, which may be a non-transitory storage medium. For instance, the computer program product could contain program modules. These program modules may be stored on CD-ROM, DVD, magnetic disk storage product, flash media or any other computer readable data or program storage product. The software modules in the computer program product may also be distributed electronically, via the Internet or otherwise, by transmission of a data signal (in which the software modules are embedded) such as embodied in a carrier wave.

For instance, the foregoing detailed description has set forth various embodiments of the devices and/or processes via the use of examples. Insofar as such examples contain one or more functions and/or operations, it will be understood by those skilled in the art that each function and/or operation within such examples can be implemented, individually and/or collectively, by a wide range of hardware, software, firmware, or virtually any combination thereof. In one embodiment, the present subject matter may be implemented via ASICs. However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, flash drives and computer memory; and transmission type media such as digital and analog communication links using TDM or IP based communication links (e.g., packet links).

1. A method of planning a route for a plurality of destinations comprising:
receiving, by a route management computing device, information about a plurality of destinations for a day, the information including an address, a time, and a duration for each destination;
calculating, by the route management computing device, an arrival time and a departure time for each of the destinations based on the time and the duration associated with each of the destinations;
ordering, by the route management computing device, the destinations in a sequence based on the time associated with the destinations;
displaying, by the route management computing device, a route to said destinations in the sequence to a user; and
determining, by the route management computing device, a time necessary to travel from each of the destinations to a following destination in the sequence, and when the arrival time for the following destination exceeds the travel time added to the departure time of the destination, then providing an alert to the user.

2. The method of claim 1, wherein the information about the plurality of destinations is selected from a database of historical routes.

3. The method of claim 2, wherein the historical route selected is amended.

4. The method of claim 1, wherein the duration for at least one of the plurality of destinations is predetermined prior to the mobile device receiving the information.

5. The method of claim 1, wherein the information about the plurality of destinations is received from a calendar program.

6. A route management computing device, comprising a processor and a memory coupled to the processor which is configured to be capable of executing programmed instructions comprising and stored in the memory to:
receive information about a plurality of destinations for a day, the information including an address, a time, and a duration for each destination;
calculate an arrival time and a departure time for each of the destinations based on the time and the duration associated with each of the destinations;
order the destinations in a sequence based on the time associated with the destinations;
display a route to said destinations in the sequence to a user; and
determine a time necessary to travel from each of the destinations to a following destination in the sequence, and when the arrival time for the following destination exceeds the travel time added to the departure time of the destination, then provide an alert to the user.

7. The device of claim 6, wherein the information about the plurality of destinations is selected from a database of historical routes.

8. The device of claim 7, wherein the historical route selected is amended.

9. The device of claim 6, wherein the duration for at least one of the plurality of destinations is predetermined prior to the mobile device receiving the information.

10. The device of claim 6, wherein the information about the plurality of destinations is received from a calendar program.

11. A non-transitory computer readable medium having stored thereon instructions for planning a route for a plurality of destinations comprising executable code which when executed by a processor, causes the processor to perform steps comprising:
receiving information about a plurality of destinations for a day, the information including an address, a time, and a duration for each destination;
calculating an arrival time and a departure time for each of the destinations based on the time and the duration associated with each of the destinations;
ordering the destinations in a sequence based on the time associated with the destinations;
displaying a route to said destinations in the sequence to a user; and
determining a time necessary to travel from each of the destinations to a following destination in the sequence, and if the arrival time for the following destination exceeds the travel time added to the departure time of the destination, then providing an alert to the user.

12. The medium of claim 11, wherein the information about the plurality of destinations is selected from a database of historical routes.

13. The medium of claim 12, wherein the historical route selected is amended.

14. The medium of claim 11, wherein the duration for at least one of the plurality of destinations is predetermined prior to the mobile device receiving the information.

15. The medium of claim 11, wherein the information about the plurality of destinations is received from a calendar program.

16. A method of planning a route for a plurality of destinations, comprising:
receiving, by a route management computing device, information about the plurality of destinations for a day, the information including a location for each destination and a time for at least one of the destinations, wherein at least another one of the destinations is not associated with an arrival time or a departure time;
calculating, by the route management computing device, an arrival time and a departure time for each of the destinations for which a time was received;
ordering, by the route management computing device, the destinations for which a time was received in a sequence based on the time associated with each of the destinations;
calculating, by the route management computing device, a spare time period between the departure time of the destinations in the sequence and the arrival time of a following destination, including a travel time associated with traveling from the destination to the following destination;
determining, by the route management computing device, if the destination not associated with a time fits within the spare period, including the travel time from the destination to the destination not associated with a time and the destination not associated with a time to the following destination; and
when the destination not associated with a time fits within the spare period:
adding, by the route management computing device, the destination to the sequence of destinations within the spare period;
generating, by the route management computing device, a route from each destination to the following destination; and
displaying, by the route management computing device, the route.
